(19) United States
(12) Patent Application Publication
(10) Pub. No.: US 2007/0059093 A1
(43) Pub. Date: Mar. 15, 2007

(54) Flanged demountable pins and bushings and method of manufacture

(76) Inventors: Victor L. Chun, Walton Hills, OH (US); Frank Madej, Mentor, OH (US)

Correspondence Address: SCHNADER HARRISON SEGAL & LEWIS, LLP, 1600 MARKET STREET, SUITE 3600, PHILADELPHIA, PA, 19103, US

(21) Appl. No.: 11/223,134

(22) Filed: Sep. 9, 2005

(51) Int. Cl. F16D 1/08

(52) U.S. Cl. 403/365

(57) ABSTRACT

A flange is formed on demountable pin and bushing guide elements made to order by assembling one or more separate pieces onto stock cut lengths to form ordered flanged pins or bushings. The flange can be formed by assembling a plurality of partially annular pieces into a reduced diameter groove in said pin, and an outer ring is press fit over the assembled pieces. The outer diameter formed by the assembled partially annular pieces is shallowly tapered and fit to a tapered inner diameter of the outer ring. The flange may alternatively be formed by shrink fitting a ring onto a cut length at a location between two shoulders machined into the element or by separate fixturing engaging the ring to accurately control the location and orientation of the flange.

### BACKGROUND OF THE INVENTION

This invention concerns guide pins and bushings used in such construction of forming dies. Forming dies are comprised of two die parts respectively mounted to an upper and lower press platen. A guide pin or post is mounted to one die part and a guide bushing mounted to the other die part in alignment with the pin. The pin and bushing mate with each other when the press is actuated to guide the die parts into accurate registry. Such pins and posts may be press fit into holes in the respective die parts, but this makes disassembly for repairs difficult so that so called “demountable” pins and bushings have been developed, in which the pin and bushing are slidably fit in the die bases, and are held with clamps engaging a flange on the pin or bushing pressing the same against the adjacent die part surface which is ground so that the pin and bushing are thereby precisely aligned with each other.

The flange has hereto been formed by machining down large diameter stock to form the pin or bushing thus producing much wasted material but also greatly adding to the time necessary to produce the pin or bushing. It thus has been necessary to manufacture and stock these items so as to achieve reasonably rapid delivery times. These requirements substantially increases costs as many configurations and sizes of pins and bushings must be available for delivery on short notice.

It is an object of the present invention to provide a method of manufacturing flanged guide pins and bushings to a customer order, allowing them to be made rapidly to order while eliminating the need for wasting time and material in machining the pins to form an integral flange, and to stock a large number of different configuration pins and bushings.

### SUMMARY OF THE INVENTION

The above object and other objects which will become apparent upon a reading of the following specification and claims are achieved by stocking lengths of standard diameter shafts and tubes which have been heat treated and precision ground to a finished inside or outside diameter. When an order is received, the shafts and/or tubes of the desired diameters are cut to length. A ring is assembled onto the pin or bushing at a specified location in such a way as to be the functional equivalent of the integral flange, i.e., a flange which is accurately controlled size, location and orientation which is sufficiently rigid to perform the retention function of an integral flange.

In a first method, a groove at the desired location of the flange is machined into the outside diameter of the pin or bushing. The pieces of a split ring having a tapered outside diameter is assembled onto the pin or bushing fit within the groove. A second ring having an inside taper which locks to the outside diameter taper of the split ring is pressed onto the split ring, creating the flange.

In a second method, the pin or bushing is machined with a double stepped diameter forming an intermediate land between large and small diameter sections thereof. A solid ring is press or shrunk fit onto a first step in abutment with a shoulder formed by a second step on the pin or bushing section.

In a third method, a solid ring is precisely located and oriented on the outside diameter of the pin or bushing by use of suitably fixturing and secured by a shrink fit to the pin or bushing outside diameter. While less strong, this method is the least expensive as no additional machining is required.

### DESCRIPTION OF THE DRAWINGS

FIG. 1 is an elevational view of a guide pin installed in a bore in a die plate, shown in section.

FIG. 2 is an elevational view in section of a guide bushing installed in a bore in a die plate, a fragmentary portion thereof also shown in section.

FIG. 3 is a much enlarged side view of a guide pin machined in preparation for installing a flange thereon according to a first method of the invention.

FIG. 4 is a pictorial view of the guide pin machined portion shown in FIG. 3 with split ring partially annular pieces partially assembled thereon.

FIG. 5 is a side view of the guide pin shown in FIG. 4 with an outer slouching ring installed over the previously assembled split ring pieces.

FIG. 6 is a pictorial view of a guide pin with the flange completely assembled thereon.

FIG. 7 is a pictorial view of a fragmentary portion of a guide bushing having a ring affixed by a second method according to the present invention.

FIG. 8 is a partially sectional view of an installed guide bushing having a ring attached as by the method shown in FIG. 7 with fragmentary portions of the associated die part.

FIG. 9 is an exploded pictorial view of the guide bushing shown in FIGS. 7 and 8.

FIG. 10 is a fragmentary elevational view in partial section of a stage in a third method according to the present invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to FIG. 1, a demountable element 10 is shown, here comprised of a pin 10, which is installed in a hole 14 in a die plate 12. The pin 10 has a flange 16 which has one face held in abutment against a ground surface 18 of the die plate 12 by a series of three or more clamps 20 secured with machine screws 22.

A land 24 on a pin segment 26 received in the hole 14 may mate with a precision ground outer section of the hole 14 for achieving precisely accurate location thereof. The flange 16 being held in abutment against the ground die surface 18 accurately aligns the pin axis normal to the surface 18 to insure proper mating engagement with a bushing on another die plate (not shown) in the well known manner. The remaining section of the pin segment 26 may be machined to be a clearance fit with the hole 14. The flange 16 must thus be accurately oriented to be normal to the pin axis.

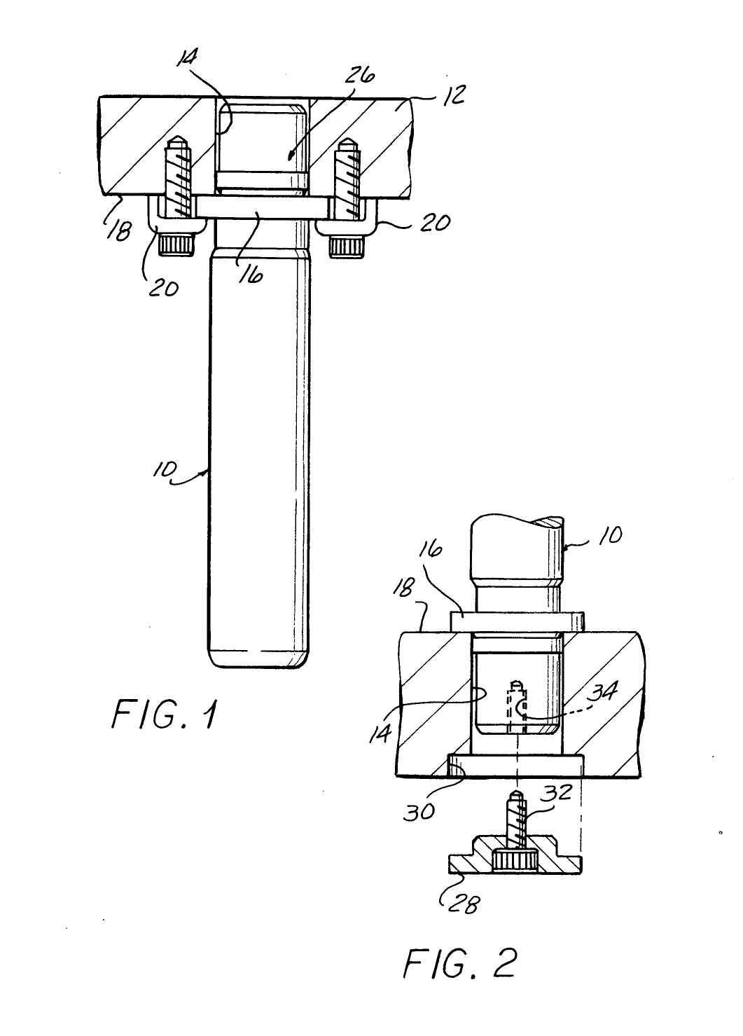

FIG. 2 shows an alternate retainer plug securement of the flange 16 with one face in abutment against the die surface 18. This includes a plug 28 able to be received in a counterbore 30 of the hole 14. A screw 32 is threadably received in a threaded hole 34 in the end of the pin 10 to advance the flange 16 against the surface 18.

According to the present invention, the flange 16 is not made by machining a larger diameter section of stock material to form an integral flange on a pin (or bushing), but rather the flange 16 is created by securing a separate piece or pieces onto a premachined pin to form the flange.

This allows stocking of standard diameter shafts and tubes which have been mostly machined. When an order is received, appropriate lengths are cut and certain details, i.e. grooves, etc. are machined into the shafts or tubes. The separate flange piece or pieces are then installed at the appropriate location.

Thus, stocking of finished pins or bushings is not necessary while allowing prompt delivery schedules for made to order pins or bushings.

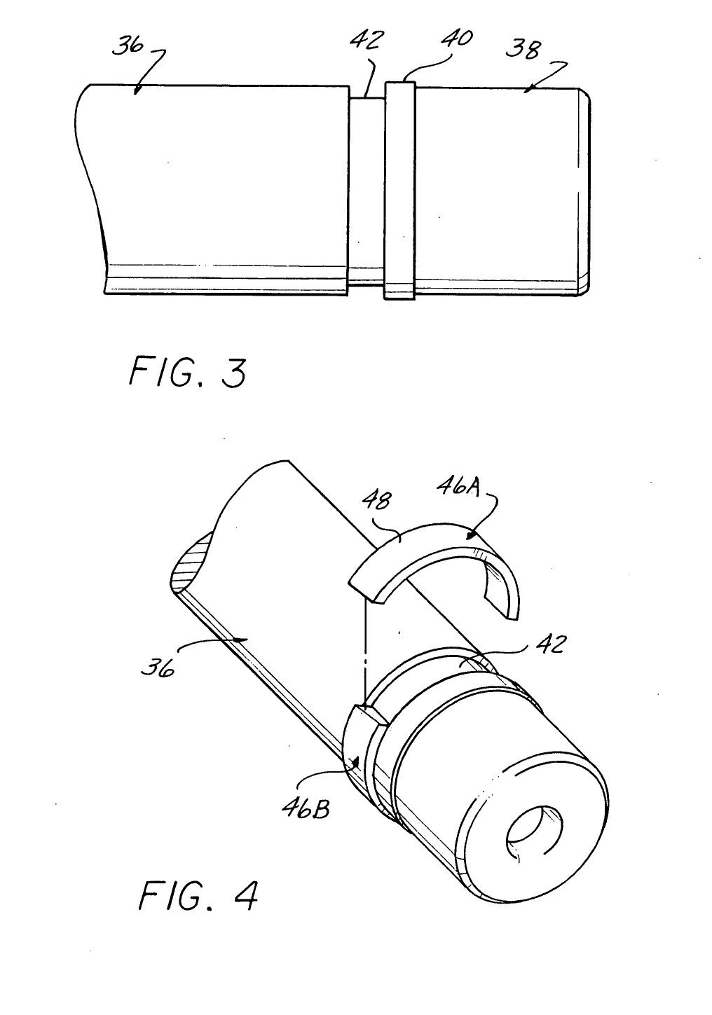

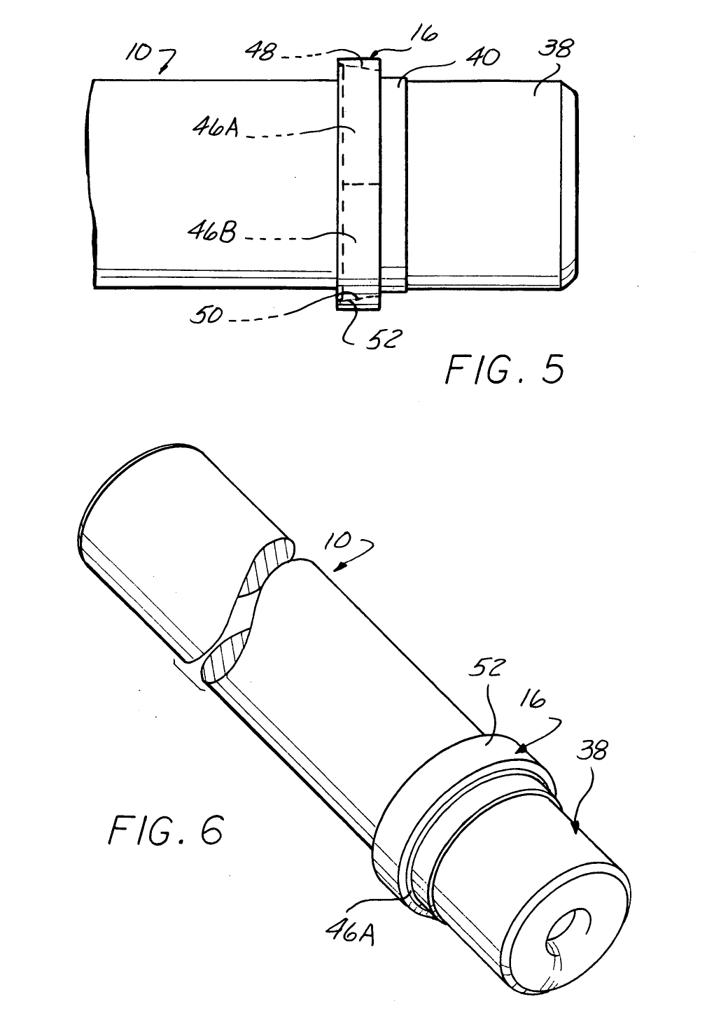

FIGS. 3-6 show a first embodiment of a method of adding a flange to a demountable element.

A pin 36 has a pre-finished diameter 40 which is the same diameter as 36, to be inserted in a hole, with a slightly smaller diameter land 38 optionally precision machined adjacent to diameter 40.

In FIG. 4, two semicircular partially annular ring segments 46A, 46B are installed in the groove 42. The segments are sized to just encircle the groove 42 and project beyond the diameter of the land 40. The outside diameter 48 of the ring formed by the two pieces 46A, 46B defines a locking taper with a tapered inside diameter 50 on an outer continuous ring 52 pressed onto the two inner pieces 46A, 46B. This forms a unitary flange 16 for use in clamping and aligning the pin 10 as described above.

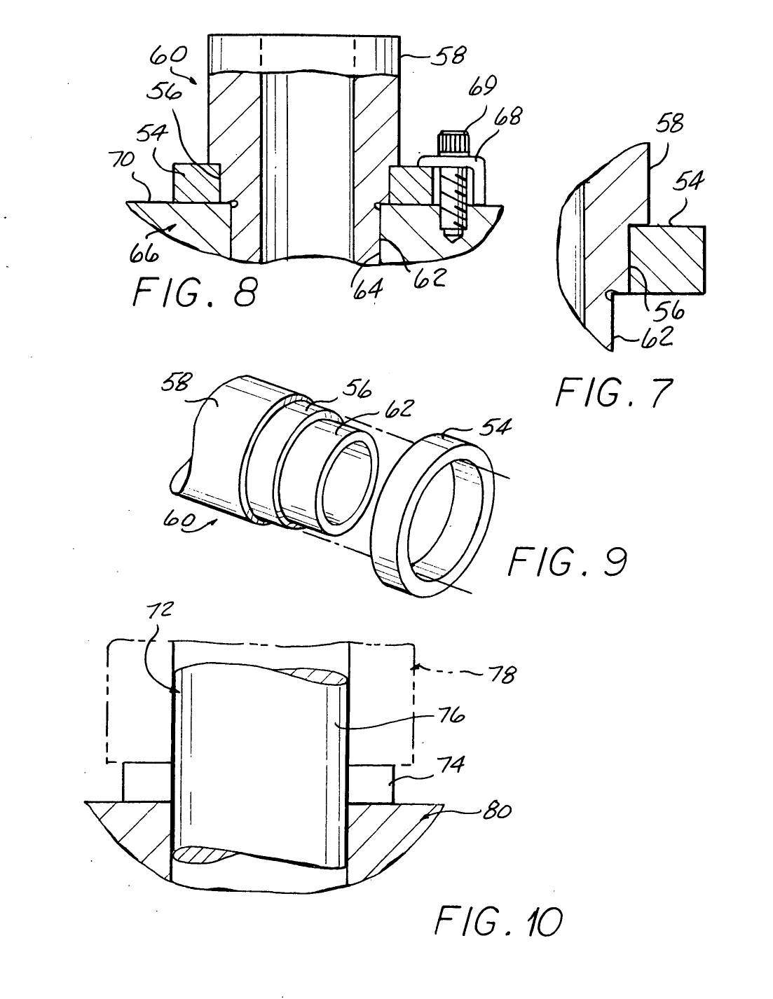

FIGS. 7-9 show a second method in which a single ring 54 is shrunk fit onto a land 56 formed between two shoulders machined into a cut length of tubular stock 58 in abutment against an outer shoulder formed by the main outside diameter of the length of stock to form a demountable bushing 60. The bushing 60 has a precision ground diameter 62 slidably fit in a precision ground bore 64 machined into a die plate 66. The abutment against the outer shoulder provides a precise axial location of the flange so formed and aids in insuring squareness of the ring 54 to the longitudinal axis of the bushing.

Three or more clamps 68 and screws 69 force one face of the flange formed by the installed ring 54 against the ground die face 70 to secure the demountable bushing 60 and align the axis thereof.

FIG. 10 shows a third, more simple method in which a pin 72 has a continuous ring 74 shrunk fit onto the outside diameter 76 of pin 72. This is done with the aid of fixturing 78, 80 to insure perfect location and squareness of the installed ring 74 shrunk fit to the pin 72 to form the flange.

This results in less strength than the above described flanges, but is adequate for the purposes described.

1. A flanged demountable pin or bushing element having a generally cylindrical shape, comprising:
said element having a main diameter section;
a groove in said main section forming a reduced diameter section on said main section;
a plurality of partially annular pieces each forming a segment of an annulus, said pieces assembled around said groove to form a complete ring having an inner radius matched to said diameter of said main section within said groove, and a taper of outside diameter shape;
a continuous outer ring having a tapered inner diameter matched to said outside diameter taper of said ring assembled from said pieces and press fit thereover to form a flange on said element.

2. A flanged demountable element according to claim 1 wherein said taper on the outside of said ring formed by assembly of said pieces and the inside of said outer ring is self locking to lock said outer ring on said ring formed by said assembled pieces.

3. A flanged demountable element according to claim 1 wherein the outside diameter of said assembled ring pieces has a minimum diameter greater than said main diameter section of said demountable element.

4. A method of manufacturing to order demountable pin or bushing elements having a generally cylindrical shape of any of a series of standard main section diameters and having a flange fixed thereof of a predetermined outer diameter greater than the outside diameter of said main section of said element comprising:
manufacturing and stocking lengths of a series of machined cylindrical stock of each of said standard diameters;
cutting said stock to ordered lengths; and
manufacturing separate at least partially annular pieces and installing said pieces onto cut stock lengths to match ordered demountable element sizes.

5. The method according to claim 4 wherein said at least partially annular elements are previously manufactured and stocked for each standard diameter elements.

6. The method according to claim 5 wherein annular segmented pieces are previously made and stocked and are assembled onto a groove to form an inner ring and are held in position by making an outer ring of a diameter equal to said desired flange outer diameter, and also having an inside diameter able to be press fit to an outer diameter of said annular pieces when assembled onto said groove and press fitting said outer ring over said outside diameter of said assembled partially annular pieces to be fixed thereto, whereat said outer ring forms a fixed flange on said element.

7. The method according to claim 6 further including forming a tapered outside diameter on said partially annular pieces to form a tapered diameter when assembled and forming a matching taper on an inner diameter of said outer ring, said outer ring press fit onto said tapered outside diameter of said partially annular pieces.

8. A method according to claim 7 wherein said mating tapering diameter of said inner diameter of said outer ring and said outer diameter of said assembled partially annular pieces comprise self locking tapers.

9. The method according to claim 4 wherein a ring is shrunk fit to each of said cut lengths at a particular location thereon.

10. The method according to claim 9 wherein said ring is located by shrink fitting said ring on a land formed by a first shoulder on said cut length and against a second shoulder formed thereon.

11. The method according to claim 9 wherein said ring is shrink fit at a location on said cut length by fixturing engaging said ring during shrink fitting.
